(19) United States
(12) Patent Application Publication
(10) Pub. No.: US 2010/0012846 A1
(43) Pub. Date: Jan. 21, 2010

(54) NOVEL SCINTILLATION DETECTOR ARRAY AND ASSOCIATE SIGNAL PROCESSING METHOD FOR GAMMA RAY DETECTION WITH ENCODING THE ENERGY, POSITION, AND TIME COORDINATIES OF THE INTERACTION

(75) Inventor: Yu Wang, Pearland, TX (US)

Correspondence Address: OSHA LIANG L.L.P., TWO HOUSTON CENTER, 909 FANNIN, SUITE 3500, HOUSTON, TX, 77010, US

(73) Assignee: YU WANG, Pearland, TX (US)

(21) Appl. No.: 12/518,869

(22) PCT Filed: Jul. 30, 2008
(86) PCT No.: PCT/US08/71559

§ 371 Date: Jun. 11, 2009

(30) Foreign Application Priority Data
Jul. 31, 2007 (US) 60963028

(51) Int. Cl. G01T 1/161; G01T 1/20

(52) U.S. Cl. 250/362; 250/366; 250/363.04

(57) ABSTRACT

A gamma ray detector module includes at least one scintillation detector configured to operate in a dot-decoding mode, or at least two scintillation detectors configured to operate in a line-decoding mode, wherein the at least one scintillation detector is each coupled to a single photodetector, and wherein the at least two scintillation detectors are coupled to at least two photodetectors arranged substantially along a line; and at least four scintillation detectors configured to operate in a plane-decoding mode, wherein the at least four scintillation detectors are coupled to a plurality of photodetectors arranged in a two-dimensional array.

### BACKGROUND

Devices for detecting the distribution of gamma rays transmitted or emitted through objects to study the compositions or functions of the objects are well known. These devices are typically used in Emission Computed Tomography, which can be divided into two specific classes: Single Photon Emission Computed Tomography (SPECT), which uses radiotracers that emit gamma rays but do not emit positrons, and Positron Emission Tomography (PET), which uses radiotracers that emit positrons. The fundamental physical difference between the two techniques is that PET uses annihilation coincidence detection, and SPECT does not.

PET can determine, in-vivo, biochemical functions, after injection of biochemical analog radiotracer molecules that emit positrons in a living body. The positrons annihilate with surrounding electrons in the subject body to produce a pair of gamma-rays, each having 511 keV of photon energy traveling in nearly opposite directions. The detection of a pair of annihilation gamma-rays by two opposed detectors allows for the determination of the location and direction in space of a trajectory line defined by the opposite trajectories of the gamma-rays. Tomographic reconstruction is then used to superpose the numerous trajectory lines obtained by surveying the subject with an array of detectors to image the distribution of radiotracer molecules in the living body.

Emission Computed Tomography systems employ a variety of geometric configurations for the gamma-ray detectors. The choice of configuration is typically dictated by the desired system performance and cost. The detector design must be capable of providing accurate estimates of gamma-ray energy and position coordinates. In addition, in the case of PET, the detector should also provide coincidence time interval. Data from these detectors allows one to reconstruct an image of the distribution of the radiotracer for in vivo studies.

Various detector designs have been reported. For example, U.S. Pat. No. 4,750,972, issued to Casey et al., discloses a position encoder and detector system that includes a two-dimensional photon counting position encoder detector. This encoder/detector uses an array of scintillation crystals to provide the transverse coordinates (i.e., X and Y coordinates) of the photon interaction; however, this detector does not determine the longitudinal (i.e., the Z coordinate) photon interaction position of the excited scintillation crystal. Photons impinging upon such detector systems at angles other than normal may traverse the path of several scintillation crystals, resulting in uncertainty of their trajectory lines, thereby degrading the image resolution due to parallax error.

U.S. Pat. No. 5,319,204, issued to Wong et al., discloses another approach to encoding position and energy of a gamma interaction by offsetting the edges between the arrays of crystals in relation to the edges between the light detectors. Each light detector is suitably positioned adjacent four adjacent quadrants of four respective arrays to simultaneously detect radiation emitted from the four quadrants of each array. However, this patent does not teach whether and how a light guide can be used to distribute scintillation light over a plurality of photodetectors.

U.S. Pat. No. 4,843,245, issued to Lecomte, discloses a detector system capable of providing both the transverse and longitudinal position of photon interactions in scintillation crystals. The approach involves the use of two scintillation crystals having different decay times. The two scintillation crystals are arranged in a stack. The position of photon interaction is then determined by the Pulse Shape Discrimination technique. Although this method is capable of providing the transverse and longitudinal position coordinates of photon interactions in scintillation crystal detector systems, it will result in reduced system efficiency if the overall scintillator depth is kept constant for two different scintillator materials—i.e., each of the two different scintillation layers is thinner. On the other hand, if the scintillators are increased in length (i.e., thicker) to compensate for the efficiency loss, then the system resolution will be degraded.

Another approach to determining the transverse and longitudinal positions of photon interactions in scintillation crystal detector systems was disclosed in U.S. Pat. No. 5,122,667, issued to Thompson. This approach differs from that of Lecomte in that a single scintillator is used. Furthermore, the method does not depend on decay time differences. The method uses a scintillation light absorbing band located at the median interaction coordinate for a specific energy along the longitudinal axis of the scintillation crystal. The net effect is to divide the scintillation crystal into two regions, with which the photon (gamma ray) is equally likely to interact. Pulse Height Discrimination is then used to determine which of the two regions of the scintillator interacted with the photon. This approach has the undesired effect of reducing the total collected scintillation light and causing the Compton continuum of the high light yield scintillator to overlap with the photopeak region of the low light yield scintillator. The result is inherent uncertainty in the contribution of scatter to the full energy photopeak.

In U.S. Pat. No. 5,349,191, issued to Rogers, a method is disclosed for determining the transverse and longitudinal position coordinates for interactions in scintillation crystal arrays. This method depends on the continuous variation of the total collected light with the longitudinal photon interaction coordinate of the light emission. The continuous variation in the collected light requires a complex calibration of each detector as a function of longitudinal photon interaction coordinate from a collimated beam of photons directed at known positions along the length of the scintillator. This calibration method is difficult to implement for large arrays of scintillators.

The detector systems described above are specific for PET, when they are used in medical imaging. The predominant scintillator materials for these detectors are Gadolinium Oxyorthosilicate (GSO), Cerium doped Lutetium-Yttrium OxyorthoSilicate (LYSO) and Lutetium OxyorthoSilicate (LSO), Lanthanum Halide scintillator (for example, LaCl₃ and LaBr₃), as well as Bismuth Germanate (BGO), though other materials have been proposed or used. The SPECT detector systems are different in that Thallium doped Sodium-Iodide (NaI(Tl)) is typically used as the scintillator material. Furthermore, the SPECT systems typically use large continuous slabs of NaI(Tl) optically coupled to a continuous light guide. Anger logic is then used to locate the scintillation event.

The exception to continuous NaI(Tl) slab detector systems for SPECT imaging was disclosed by Govaert in U.S. Pat. No. 4,267,452. This detector system is unique as a SPECT detector in that it is segmented. The segmentation of the NaI(Tl) is similar to PET block detector designs that use an active light guide. The detector system disclosed by Govaert does not result in discrete scintillator elements whereby each element is a separate detector. Instead, the segmentation results in a block of NaI(Tl) that is subdivided into elements that share a common light guide of active scintillator material, i.e., the NaI(Tl) is not cut all the way through.

In U.S. Pat. No. 6,362,479, Andreaco et al. disclose a scintillation detector array for encoding the energy, position, and time coordinates of gamma ray interactions. This detector array has potential applications in both SPECT and PET. The disclosed embodiments teach the means to construct a scintillation detector using one or more scintillator materials by optically coupling the scintillators to photodetectors using a light guide. The light guide may be active or non-active and may be segmented or non-segmented. How ever, all of the embodiments teach the methods to manage the light distribution among four adjacent photodetectors disclosed in U.S. Pat. No. 4,750,972, issued to Casey, et al., or among four quadrants of four adjacent photodetectors similar to the embodiments disclosed in U.S. Pat. No. 5,319,204, issued to Wong, et al.

The embodiments disclosed in U.S. Pat. No. 6,362,479 are different from those disclosed in U.S. Pat. No. 4,750,972 and U.S. Pat. No. 5,319,204, in that they use a light guide to distribute light and that they have the capability of using multiple scintillating materials. Nevertheless, all these embodiments share similar fundamental principle, i.e., they always manage the distribution of scintillation light and acquire the scintillation light in a two-dimensional base. Therefore, when the gains of photodetectors are not well equalized, the scintillator position histogram will distort two-dimensionally in an unpredictable manner. As a result, it is difficulty to know which scintillators, among the photodetectors within a gamma detector array, have their position histogram that is insensitive to the gain variations. This makes it impossible to use energy spectrum/spectra of one or more scintillators to perform gain equalization in a timely manner (for instance, everyday or even during a patient scan), when the gains are unbalanced to an unacceptable extent, e.g. the variation of the gains is more than 10%.

SPECT detector system designs that are intended to bridge both the SPECT and the PET imaging modalities are known as hybrid devices. These systems have increased NaI(Tl) scintillator thickness for higher efficiency and have added coincidence detection circuitry and attenuation corrections. Despite these changes, the continuous slab of NaI(Tl) scintillator detector designs are inferior to PET specific detector designs in terms of system performance.

The above described SPECT, PET, or hybrid SPECT detectors have been useful for their intended purposes. However, there is still a need for better SPECT and/or PET detector systems, especially systems with better gain balance capabilities.

### SUMMARY OF THE INVENTION

One aspect of the invention relates to gamma ray detector modules. A gamma ray detector module in accordance with one embodiment of the invention includes at least one scintillation detector configured to operate in a dot-decoding mode, or at least two scintillation detectors configured to operate in a line-decoding mode, wherein the at least one scintillation detector is each coupled to a single photodetector, and wherein the at least two scintillation detectors are coupled to at least two photodetectors arranged substantially along a line; and at least four scintillation detectors configured to operate in a plane-decoding mode, wherein the at least four scintillation detectors are coupled to a plurality of photodetectors arranged in a two-dimensional array.

Another aspect of the invention relates to methods for imaging a gamma ray source. A method in accordance with one embodiment of the invention comprising: obtaining gamma ray measurements using a detector module comprising: at least one scintillation detector configured to operate in a dot-decoding mode, or at least two scintillation detectors configured to operate in a line-decoding mode, wherein the at least one scintillation detector is each coupled to a single photodetector, and wherein the at least two scintillation detectors are coupled to at least two photodetectors arranged substantially along a line; and at least four scintillation detectors configured to operate in a plane-decoding mode, wherein the at least four scintillation detectors are coupled to a plurality of photodetectors arranged in a two-dimensional array; and balancing gains of the scintillation detectors in the detector module using measurements obtained by the at least one scintillation detector operating in the dot-decoding mode or the at least two scintillation detectors operating in the line-decoding mode.

Other aspects and advantages of the invention will be apparent from the following description and the appended claims.

### BRIEF DESCRIPTION OF THE DRAWINGS

FIG. 1A shows a diagram of a medical instrument that uses a gamma ray detector module in accordance with one embodiment of the invention.

FIG. 1B shows an assembly of a gamma ray detector module in accordance with one embodiment of the invention. FIG. 1C shows another assembly of gamma ray detector module in accordance with one embodiment of the invention.

FIG. 2 shows a schematic of a gamma ray detector module illustrating the dot-decoding mode, the line-decoding mode, and the plane-decoding mode in accordance with one embodiment of the invention.

FIGS. 3A-3K show schematics illustrating various embodiments of dot-decoding scintillation detectors according to embodiments of the invention.

FIGS. 4A-4C show schematics illustrating various embodiments of line-decoding scintillation detectors according to embodiments of the invention.

FIGS. 5A-5C show schematics illustrating various embodiments of plane-decoding scintillation detectors according to embodiments of the invention.

FIGS. 6A-6B show schematics illustrating embodiments of scintillation detectors with a light guide according to one embodiment of the invention.

FIGS. 7A-7B show schematics illustrating a light guide according to one embodiment of the invention.

FIGS. 8A-8C show schematics illustrating a light guide according to another embodiment of the invention.

FIGS. 9A-9P show schematics illustrating various coupling patterns according to embodiments of the invention.

FIGS. 10A-10C show gamma ray measurements obtained with a conventional detector array.

FIGS. 11A-11C show gamma ray measurements obtained with a detector array in accordance with one embodiment of the invention.

FIG. 12 shows a flow chart illustrating a method for balancing gains in a detector array in accordance with one embodiment of the invention.

FIGS. 13A-13C show a schematic of a detector array in accordance with one embodiment of the invention.

FIG. 14 shows a schematic of a detector array illustrating dot-decoding mode, line-decoding mode, and plane-decoding mode detectors on the same module in accordance with one embodiment of the invention.

FIG. 15 shows a schematic illustrating a method for imaging an object using a gamma ray detector module in accordance with one embodiment of the invention.

FIG. 16 shows a schematic of a gamma ray detector module illustrating different shapes of photodetectors used in accordance with one embodiment of the invention.

### DETAILED DESCRIPTION

Embodiments of the invention relate to detectors and apparatus that can determine the energy, position and time coordinates of light emission generated by interactions between gamma rays and scintillators comprising one or more scintillating materials. Some embodiments of the invention relate to gamma detector arrays that comprise scintillator detectors (for interaction with gamma rays) coupled to photodetectors (for detection of photons generated from gamma ray interactions with the scintillator detectors). Some scintillator detectors may be optically coupled to photodetectors using a light guide, which may be segmented or non-segmented. In addition, the light guide may be active (with scintillating capability) or non-active (without scintillating capability). “Segmented” or “non-segmented” refers to whether the light guide has barriers defining a number of slots. Such segmented slots may have barriers at different depth to allow for control of statistical distributions of photons.

The individual scintillator detectors in a detector array of the invention may be discrete detectors (each detector is a separate element), non-discrete detectors (i.e., the detectors are physically attached to each other), or a combination of the two types. For ease of manufacturing, one may start with a block of scintillator material and score (cut) the block into individual detectors. The scoring (cut) may be either all the way through (discrete detectors) or partially through (non-discrete detectors). For clarity of illustration, the following description may use “discrete” detectors to illustrate embodiments of the invention. The use of “discrete detectors” is for clarity only and is not intended to limit the scope of the invention. One skilled in the art would appreciate that “non-discrete” detectors may be used to substitute for these “discrete” detectors when appropriate without departing from the scope of the invention. The photodetectors in accordance with embodiments of the invention are preferably photomultiplier tubes or photodiodes. However, any conventional photodetectors may be used with embodiments of the invention.

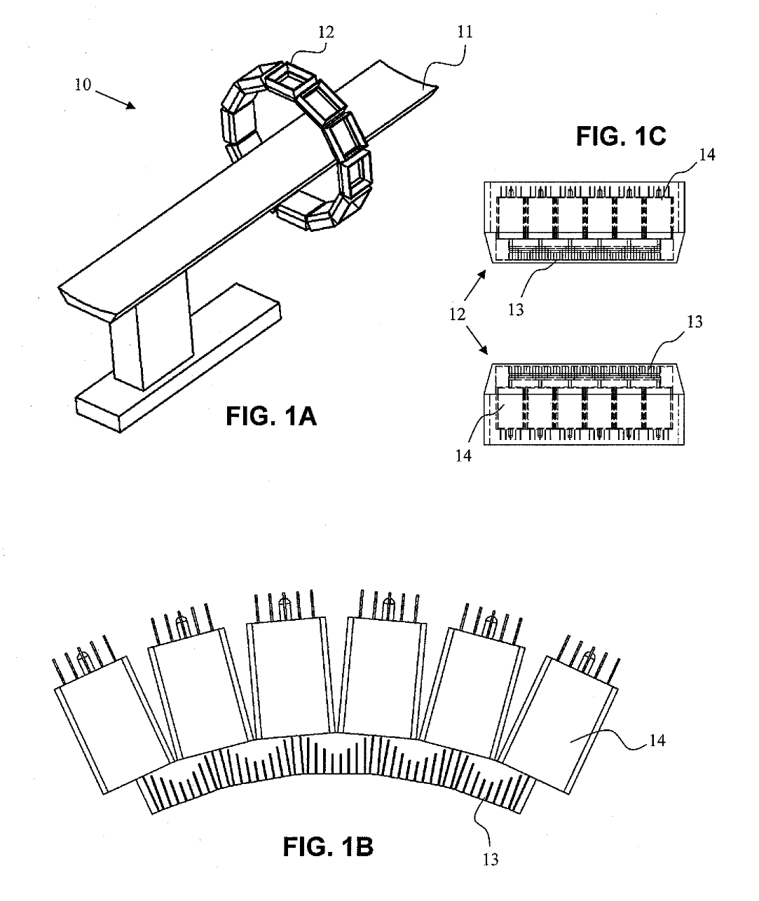

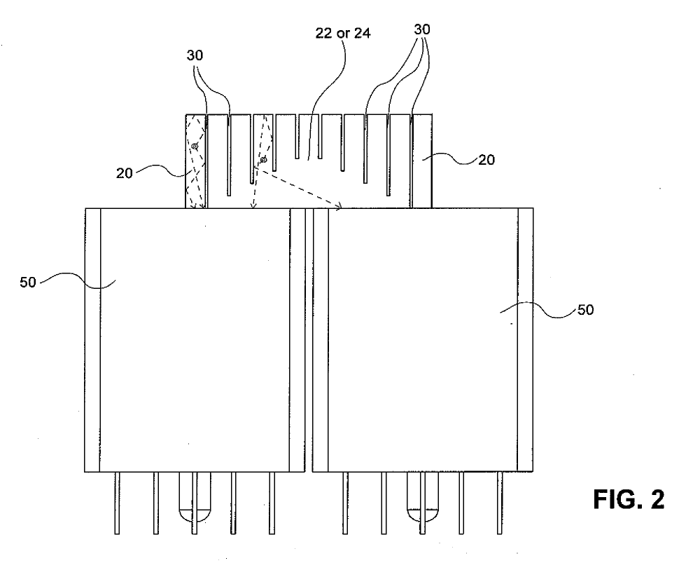

Detector arrays of the invention may be used in any instrument that requires a gamma detector. For example, as shown in FIG. 1A, gamma detector arrays of the invention may be used with a medical imaging instrument 10 (which may be a PET), which includes a patient bench 11 and a ring assembly (e.g., gamma camera) comprising multiple gamma detector arrays 12. The detector ring may comprise gamma detector arrays 12 arranged in an arcuate (arc) configuration, such as that shown in FIG. 1B. FIG. 1B shows a gamma ray detector array 12 that comprises one or more scintillator detectors 13 coupled to one or more photodetectors 14.

In accordance with some embodiments of the invention, the gamma ray detector arrays 12 are not arranged in an arc or ring configuration. For example, FIG. 1C shows a configuration having two gamma detector arrays 12 arranged opposite to each other for detecting a gamma ray source placed between them. Gamma detector arrays of the invention may be used with any instruments known in any configurations.

Since its introduction by Anger in U.S. Pat. No. 3,011,057, the light sharing scheme has been broadly exploited in medical instruments to accurately measure the location of a gamma ray emitter (e.g., a radioactive tracer in a patient or a research object) using a scintillator. The fundamental concept, as disclosed by Anger, is to distribute scintillation light two-dimensionally over an array of two-dimensionally disposed photodetectors. The relative intensities of light collected by the 2D array of detectors are then used to determine the location of the scintillation event in a manner similar to triangulation. This concept has been carried through in most nuclear medical imaging devices. However, the accuracy of this approach depends on the accuracy of relative intensity measurements among the 2D array detectors. As a result, any gain imbalance among the detectors will degrade the accuracy of the final results.

To provide easier gain monitoring or balancing, embodiments of the present invention use multiple optical coupling mechanisms in the scintillator detectors and/or the light guide to control the light distribution over the photodetectors. These optical coupling mechanisms may further regulate the amount of light being acquired and detected by photodetectors. In accordance with embodiments of the invention, the optical coupling mechanisms may be classified into three light distribution and acquisition modes, namely the dot-decoding mode, the line-decoding mode and the plane-decoding mode. As described in more detail below, the detectors in the dot-decoding mode are less sensitive to inaccuracy caused by gain imbalance and, therefore, can be used to provide an easier way to monitor and balance the gains of detectors in the array.

The dot-decoding mode allows the light emitted from a scintillator to spread over and be acquired by a single photodetector in an array of photodetectors. Thus, the dot-decoding mode lights up a single photodetector (i.e., a single “dot” in a 2D array). The line-decoding mode allows the light emitted from a scintillator to spread over and be acquired by two or more adjacent photodetectors (or portions thereof) in a substantially linear (1D) arrangement. Thus, the line-decoding mode lights up a line of photodetectors (i.e., a “line” in a 2D array). In accordance with some embodiments of the invention, the photodetectors in the line-decoding mode may or may not be shared with the photodetector used in the above mentioned dot-decoding mode within the array of photodetectors, i.e., separate photodetectors may be used for different modes of detection.

The plane-decoding mode allows the light emitted from a scintillator to spread over and be acquired by four or more adjacent photodetectors (or portions thereof) in a plane (2D) arrangement (e.g., four or more photodetectors arranged side-by-side to from a square, rectangular, or other shape). Thus, the plane-decoding mode lights up an area of photodetectors (a “plane” or region in a 2D array). In accordance with some embodiments of the invention, the photodetectors in the plane-decoding mode may or may not be shared with the photodetectors used in the above mentioned dot-decoding or line-decoding modes within the array of photodetectors, i.e., different photodetectors may be used for different modes. By combining these three modes using photodetector arrays with different sizes and their associated scintillators, with or without a light guide, gamma detectors of different sizes can be fabricated in accordance with embodiments of the invention.

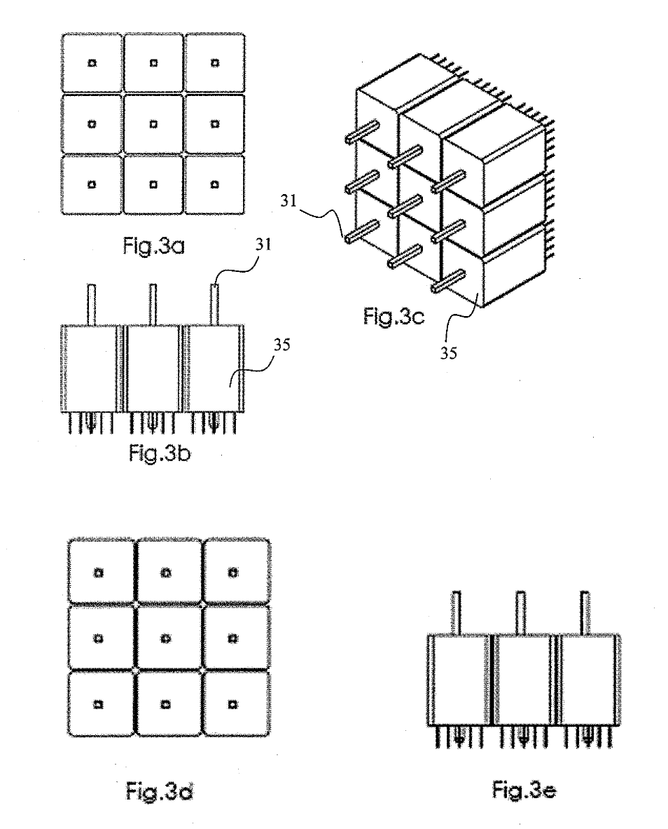

FIG. 2 illustrates how the dot-decoding mode, line-decoding mode, and plane-decoding mode work. As shown in FIG. 2, one or more reflective materials 30 (e.g. white paint, reflective film, or Teflon tape) may be used to cover the outside surfaces of a dot-decoding detector 20, except for the one or more surfaces optically coupled to the photodetector 50. There may be separations or no separations between the detector surfaces and the reflectors. The purpose of the reflectors (or optical barriers) is to maximize the light collection and to minimize the optical cross-talk with other functionally unrelated photodetectors (e.g., to confine the light collection to a single photodetector in the dot-decoding mode) in order to achieve the desirable decoding mode. A s showed in FIG. 2, the dash lines illustrate the light trajectories in dot-decoding detector 20. The scintillation light is intentionally confined (reflected) by reflectors or optical barriers 30 and collected by a single photodetector 50. Also shown in FIG. 2, the dash lines illustrate the light trajectories in line-decoding detector 22 or plane-decoding detector 24. The scintillation light is intentionally managed (reflected) by reflectors or optical barriers 30 and collected by more than one photodetectors 50.

Note that the dot-decoding detector 20 is completely separated (or substantially so) from other scintillator detectors, i.e., the scoring or cut in the scintillator block is either all the way through or substantially all the way through, such that the lights from this detector will be directed to a single photodetector. Alternatively, the dot-decoding scintillator crystal may be constructed of a separate piece (e.g., a precut crystal) that is assembled with other scintillator crystals. Note that if a light guide is used between the scintillator detector and the photodetector, the light guide preferably should have similar light-sharing minimization feature so that the light from the crystal will be directed to a single photodetector.

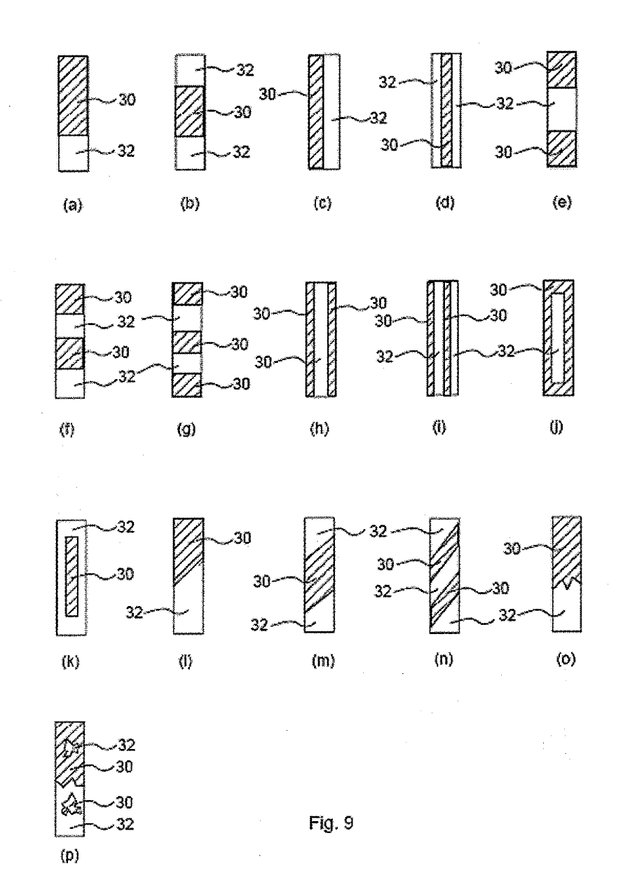

Referring again to FIG. 2, for line-decoding detectors 22, there are partial separations (partial scoring or cuts in the case of non-discrete detectors, or partially covered by the reflectors or optical barriers with some desirable patterns depicted in FIG. 9 in the case of discrete detectors) between neighboring crystals such that part of the neighboring crystals are joined to allow partial light sharing, i.e., light generated from a scintillation event in one crystal can be distributed over a linear array of photodetectors. Note that if a light guide is used between the scintillator detector 22 and the photodetector 50, then the light guide may provide the partial light sharing mechanism. In that case, the crystals in the line-decoding detectors 22 may be completely separated (or substantially so) from the neighboring crystals. Similarly, for plane-decoding detector 24, there will be light sharing mechanism either in the crystals or in the light guide (if a light guide is used) to allow light generated in one crystal to be distributed in a 2D array of photodetectors.

Within the dot-decoding detector 20, the scintillation light is intentionally confined by reflectors or optical barriers 30 and collected by one photo-detector. Within the line-decoding detector 22 and the plane-decoding detector 24, the scintillation light is intentionally confined by reflectors or optical barriers 30 and collected by more than one photodetectors. The difference between a line-decoding detector 22 and a plane-decoding detector 24 is that: with the line-decoding detector 22, the reflectors or optical barriers 30 are arranged in a way that the scintillation light can distribute over a linearly disposed photodetector array, while with the plane-decoding detector 24, the reflectors or optical barriers 30 are arranged in a way that the scintillation light can distribute over a two dimensionally disposed photodetector array.

As noted above, scintillator detectors in the dot-decoding mode include a feature for minimizing light sharing with other photodetectors that are unrelated to the dot-decoding mode. The light sharing minimization feature may be accomplished with a reflective coating on the outside surfaces of the detector crystal, as discussed above. In addition, any other means to prevent light sharing known in the art may also be used, such as highly polished outside surface, special surface treatments (e.g., ion infusion), and the like.

In accordance with embodiments of the invention, measurements from the dot-decoding mode may be used to monitor or calibrate gains of the photodetectors. When the gain differences among the photodetectors are not well compensated for, the light-sharing minimizing feature can restrict the position-histogram distortion in the discrete detectors involved in the dot-decoding mode to a smaller and more predictable region. Therefore, the discrete detectors in the dot-decoding mode can be located more easily and consistently, even if the position histograms of all other non-dot-decoding mode detectors distort in an unpredictable manner due to variations in the gains of the photodetectors.

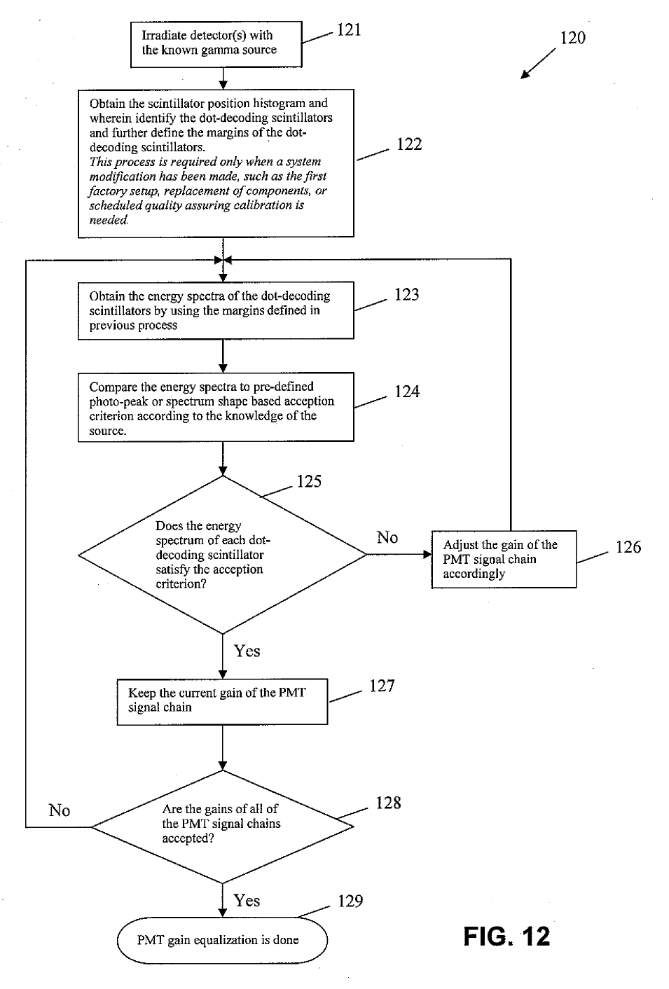

With this feature (i.e., minimization of light sharing), one can irradiate a gamma detector of the invention with a known radioactive isotope and choose the discrete scintillator detectors in the dot-decoding mode to generate energy spectra that can then be used to assess and, accordingly, adjust the gains of the photodetectors that the discrete scintillator detectors in the dot-decoding mode report to (i.e., coupled to). How to adjust the gain of a detector using a known energy level of radiation is well understood by one skilled in the art. FIG. 12 (see the later section) shows a flow chart of one example for adjusting the gains of the detectors.

In accordance with embodiments of the invention, every photodetector within a detector array of the invention may be designed to operate in its own dot-decoding mode, i.e., as a discrete scintillator detector. Thus, the gain of every photodetector in a detector array of the invention may be monitored and calibrated as described above. A further advantage of this approach is that the gain equalization can be carried out even during a patient scan, by analyzing the energy spectra of the dot-decoding mode detectors and adjusting the gains of photodetectors in accordance with the known radioactive tracer injected into a patient.

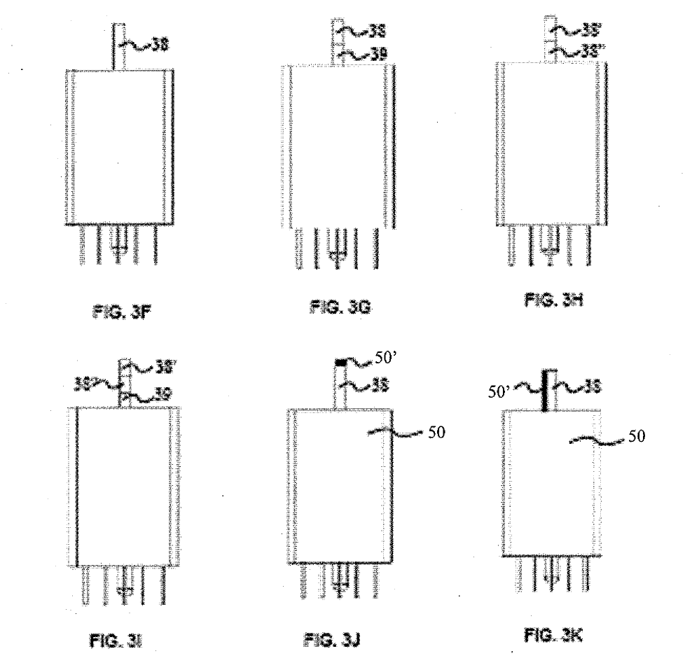

As shown in FIGS. 3A-3C, the dot-decoding detector (i.e., scintillator) 31 resides over one photodetector 35 (e.g., photomultiplier tube or photodiode) and occupies, physically and optically, a portion of the sensitive area of the photodetector 35. Preferably, the residence and occupancy is at the center of the photodetector (as shown in FIGS. 3A-3C). However, in accordance with embodiments of the invention, dot-decoding detectors 31 can also be off-centered (FIGS. 3D, 3E). Furthermore, the center-to-center shift between each dot-decoding detector 31 and its associate photodetector 32 may also be different. The dot-decoding detector (scintillator) 31 may comprise one or more scintillating materials and may be segmented or non-segmented. Furthermore, the dot-decoding detector 31 may be optically coupled to the photodetector 32 directly or through a light guide. The light guide can be either segmented or non-segmented and either active or non-active. One or more reflective materials (e.g. white paint, reflective film, Teflon tape) may be used to cover the dot-decoding detector 31 outside surfaces except for the one or more surfaces optically coupled to the photodetector 35. There can be either separations or no separations between the dot-decoding detector 31 surfaces and the reflectors. The purpose of the reflectors is to maximize the scintillation collection and to minimize the scintillation cross-talk with the other functionally irrelevant photodetectors and further to realize the dot-decoding mechanism.

In accordance with embodiments of the invention, a dot-decoding detector may comprise one single piece of scintillator, as shown in FIG. 3F. In addition, other variations or modification of this basic construction is possible without departing from the scope of the invention. For example, FIG. 3G shows an alternative embodiment of a dot-decoding detector comprising one piece of scintillator 38 stacked on one piece of an active or non-active light guide 39. FIG. 3H shows one embodiment of a dot-decoding detector comprising one piece of scintillator 38′ stacked on another piece of scintillator 38″ with different decay time. The scintillators in this embodiment can be same or different materials. FIG. 3I shows one embodiment of a dot-decoding detector comprising two pieces of scintillators 38′,38″ with different decay time stacked on one piece of a non-active light guide 39. The scintillators in this embodiment can be same or different materials.

In accordance with some embodiments of the invention, more than one photodetectors (e.g., photomultipliers) may be used to sense the scintillation emitted from a dot-decoding detector/scintillator. For example, FIG. 3J shows one embodiment with a PMT 50 coupled to one surface of the dot-decoding detectors and a photodiode 50′ coupled to the opposite surface. FIG. 3K shows another embodiment with a PMT 50 coupled to one surface of the dot-decoding detectors and a photodiode 50′ coupled to one or more side surfaces adjacent to the PMT coupled surface.

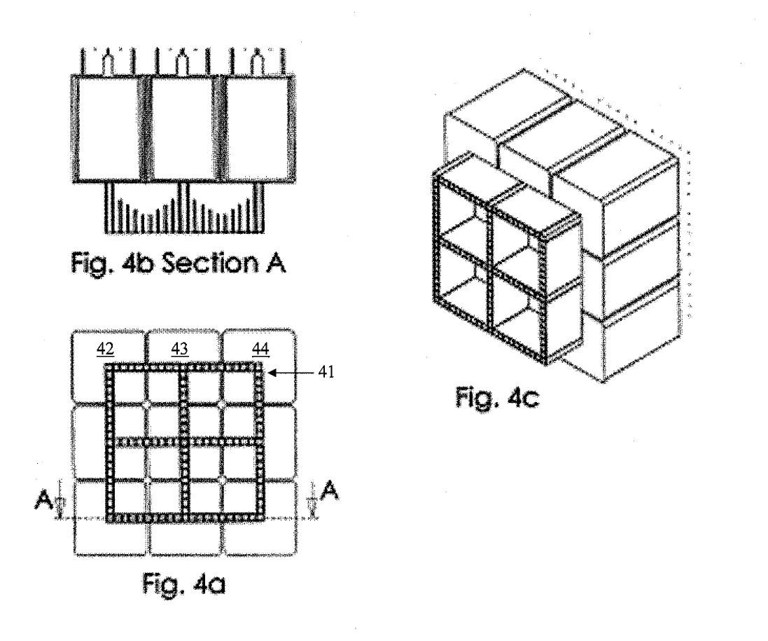

As noted above, gamma ray detectors in accordance with some embodiments of the invention may be operated in a line-decoding mode. FIGS. 4A-4C shows one such embodiment, in which a line-decoding detector 41 resides over two or more adjacent photodetectors 42,43,44 (e.g., photomultiplier tubes) and occupies, physically and optically, portions of the sensitive areas of the photodetectors. Preferably, the line-decoding detector 41 resides and occupies over the centerline passing through the centers of the two or more adjacent photodetectors 42,43,44. However, other embodiments may have an off-centered configuration, in which the line-decoding detectors are shifted from the centerline of the photodetectors.

Similar to the dot-decoding detectors described above, a line-decoding detector in accordance with embodiments of the invention may comprise one or more scintillating materials, which may be segmented or non-segmented, and may be optically coupled to a photodetector directly or through a light guide. The light guide may be either segmented or non-segmented and may be either active or non-active. Therefore, various combination and modifications are possible without departing from scope of the invention.

For example, a line-decoding detector may comprise one single piece of scintillator grooved with various depths. Alternatively, a line-decoding detector may comprise two or more pieces of discrete scintillators optically bonded together with light distributing patterns designed to spread the light over a linear array of photodetectors. Some embodiments of the line-decoding detectors may comprise a linear array of scintillators stacked on a linear array of non-active light guide. Note that these examples are for illustrations only and are non-exhaustive. One skilled in the art would appreciate that other variations or modifications are possible without departing from the scope of the invention.

Other embodiments of the line-decoding detectors may comprise a linear array of scintillators stacked on top of another linear array of scintillators with different decay times. The scintillators in this embodiment can be same or different materials. In accordance with some embodiments of the invention, such stacked linear array of line-decoding detectors may be further coupled to a linear array of non-active (or active) light guide.

Moreover, some embodiments can use more than one photodetectors to sense the scintillation emitted from the line-decoding detector. For example, one or more PMTs may be coupled to one surface of the line-decoding detectors and one or more photodiodes are coupled to the opposite surface (see examples described in U.S. Pat. No. 6,362,479).

In accordance with embodiments of the invention, optical coupling patterns may be used to control statistical photon distribution over the two adjacent photodetectors. Techniques for creating such optical patterns are well known in the art. For example, the optical patterns can be created using any of the following techniques: (1) treating the surfaces of scintillators mechanically or chemically (e.g. mechanical polishing or lapping, or chemical etching); (2) cutting slots into scintillators and/or light guides with various depths; (3) stuffing optical barriers or reflectors into the slots created by (2) or between the discrete pieces of scintillator and light guide; (4) optically bonding the segments of scintillators and/or light guide. One or more reflective materials (e.g. white paint, reflective film, Teflon tape) may be used to cover the line-decoding detector outside surfaces except for the one or more surfaces coupled to the photodetectors. There can be separations or no separations between the detector surfaces and the reflectors. The purpose of the reflectors is to maximize the scintillation collection and to minimize the scintillation cross-talk with other functionally unrelated photodetectors and further to realize the line-decoding mechanism.

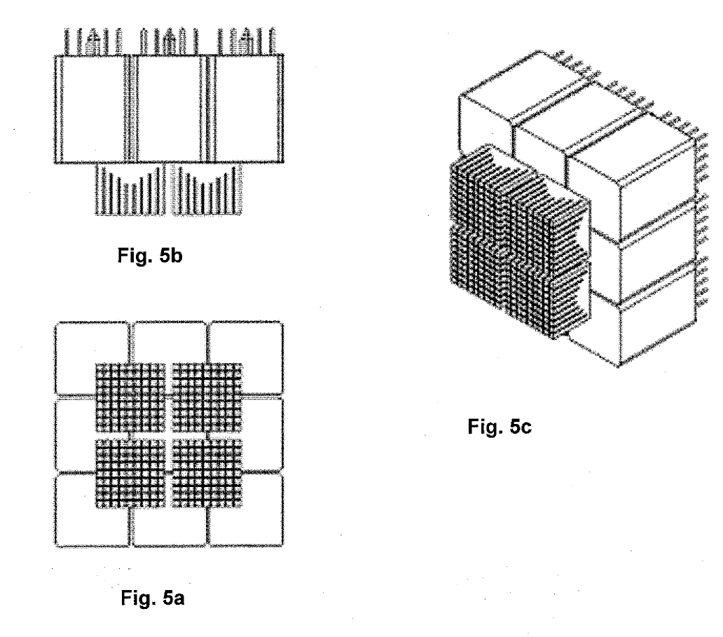

As noted above, some embodiments of the invention may have the detectors operating a plane-decoding mode. FIG. 5 shows one such embodiment, in which a plane-decoding detector may reside over four adjacent photodetectors (e.g., photomultiplier tubes) and may occupy, physically and optically, portions of the sensitive areas of the photodetectors. The remaining portions (or part of that) of the sensitive areas of the photodetectors may be taken up by dot-decoding detectors and/or line-decoding detectors. Preferably, the plane-decoding detector takes up the portions of the adjacent photodetectors in a symmetrical manner, as shown in FIG. 5A. However, embodiments the plane-decoding detectors may also be asymmetrically positioned over the photodetectors.

In accordance with embodiments of the invention, a plane-decoding detector may comprise one or more scintillating materials and may be segmented or non-segmented. In addition, a plane-decoding detector may be optically coupled to a photodetector directly or through a light guide. If a light guide is used, the light guide may be either segmented or non-segmented and may be either active or non-active.

As noted above, optical coupling patterns may be used to control the statistical photon distribution over the photodetectors. The coupling patterns can be realized by means of using any or all of the techniques described above, i.e., (1) treating the surfaces of scintillators mechanically or chemically (e.g. mechanical polishing or lapping, chemical etching); (2) cutting slots into scintillator and/or light guide with various depths; (3) stuffing optical barriers or reflectors into the slots created by (2) or between the discrete pieces of scintillator and light guide; (4) optically bonding the segments of scintillators and/or light guide.

In addition, one or more reflective materials (e.g. white paint, reflective film, Teflon tape) may be used to cover the plane-decoding detector outside surfaces except for the one or more surfaces coupled to the photodetectors. In accordance with some embodiments of the invention, there may be separations or no separations between the detector surfaces and the reflectors. The purpose of the reflectors is to maximize the scintillation collection and to minimize the scintillation cross-talk with other functionally unrelated photodetectors.

For example, some embodiment of the plane-decoding detectors may comprise one single piece of scintillator grooved with various depths. Some embodiments of the plane-decoding detectors may comprise two or more pieces of discrete scintillator optically bonded together with light distributing patterns. Other embodiments of the plane-decoding detectors may comprise an array of scintillators stacked on an array of non-active light guide. Furthermore, the plane-decoding detectors may comprise an array of scintillators stacked on another array of scintillators with different decay time. The scintillators in this embodiment can be same or different materials. In addition, embodiments of the plane-decoding detectors may comprise two arrays of scintillators with different decay time stacked one on one and together coupled to an array of non-active light guide. The scintillators in this embodiment can be same or different materials.

Moreover, some embodiments can use more than one photodetectors to sense the scintillation emitted from the line-decoding detector. For example, a PMT may be coupled to one surface of the plane-decoding detectors and a photodiode may be coupled to the opposite surface. Some embodiments of the invention may include light guides (active or non-active) between the scintillator detectors and the photodetectors. The light guides may be constructed using any techniques described above.

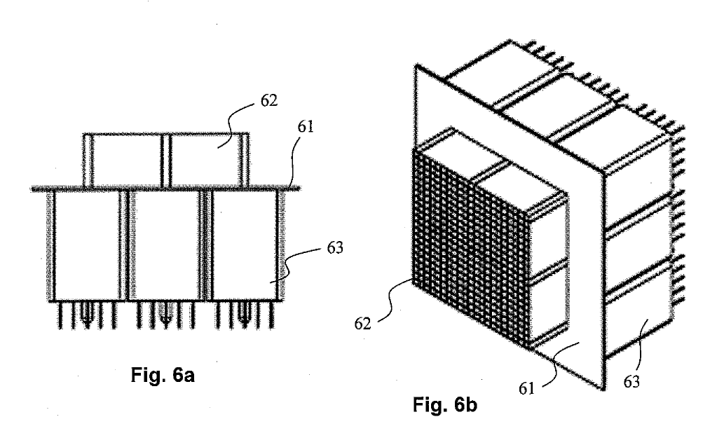

FIGS. 6A-6B show one example, in which a thin continuous light guide 61 is disposed at the optical interface between the scintillator detectors 62 and the photodetectors 63. The thin continuous light guide 61 functions as a simple intermediary between the scintillator detectors 62 and photodetectors 63. In accordance with embodiments of the invention, a light guide does not have to be continuous, nor does it need to be thin.

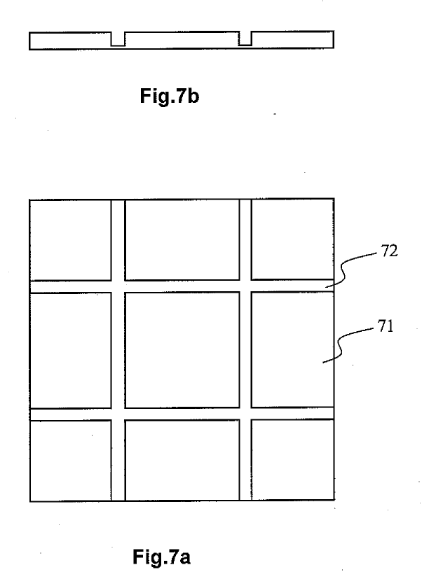

FIGS. 7A-7C show an example of a moderately thick continuous light guide 71, which may be used to create an optical interface between scintillator detectors and photodetectors. In this light guide 71, moats 72 (troughs) may be made to accommodate the dot-decoding detectors and/or the line-decoding detectors.

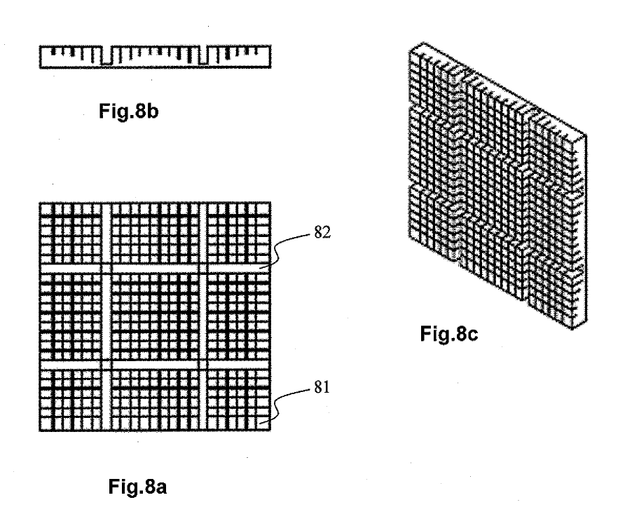

FIGS. 8A-8C show yet another example of a light guide 81, which is a moderately thick continuous light guide grooved to various depths. The grooved regions are designed to function as an interface between plane-decoding detectors and photodetectors, while moats 82 may be made to accommodate the dot-decoding detectors and line-decoding detectors.

In accordance with embodiments of the invention, optical coupling between the scintillator and light guide can be designed in various configurations. FIG. 9 shows some exemplary embodiments of optical coupling patterns for controlling statistical photon distribution within the line-decoding detectors and/or the plane-decoding detectors. The exemplary embodiments shown in FIG. 9 include:
(a) shows a pattern of two sections, one is 30, one is 32, the border the two sections joining each other is a straight line parallel to the short side of optical coupling interface between the scintillators and/or light guide;
(b) shows a pattern of three sections, one is 30, the other two are 32, the borders the every two adjacent sections joining each other are straight lines parallel to the short side of optical coupling interface between the scintillators and/or light guide;
(c) shows a pattern of two sections, one is 30, one is 32, the border the two sections joining each other is a straight line parallel to the long side of optical coupling interface between the scintillators and/or light guide;
(d) shows a pattern of three sections, one is 30, the other two are 32, the borders the every two adjacent sections joining each other are straight lines parallel to the long side of optical coupling interface between the scintillators and/or light guide;
(e) shows a pattern of three sections, two are 30, the other one is 32, the borders the every two adjacent sections joining each other are straight lines parallel to the short side of optical coupling interface between the scintillators and/or light guide;
(f) shows a pattern of four sections, two are 30, the other two are 32, the borders the every two adjacent sections joining each other are straight lines parallel to the short side of optical coupling interface between the scintillators and/or light guide;
(g) shows a pattern of five sections, two are 30, the other three are 32, the borders the every two adjacent sections joining each other are straight lines parallel to the short side of optical coupling interface between the scintillators and/or light guide; inductively, there can be a arbitrary number (n) sections, (n−1)/2 are 30, (n+1)/2 are 32 or vice versa when n is an odd number, or n/2 are 30, n/2 are 32 or vice versa when n is an even number, the borders the every two adjacent sections joining each other are straight lines parallel to the short side of optical coupling interface between the scintillators and/or light guide.
(h) shows a pattern of three sections, two are 30, the other one is 32, the borders the every two adjacent sections joining each other are straight lines parallel to the long side of optical coupling interface between the scintillators and/or light guide;
(i) shows a pattern of four sections, two are 30, the other two are 32, the borders the every two adjacent sections joining each other are straight lines parallel to the long side of optical coupling interface between the scintillators and/or light guide; inductively, there can be a arbitrary number (n) sections, (n−1)/2 are 30, (n+1)/2 are 32 or vice versa when n is an odd number, or n/2 are 30, n/2 are 32 or vice versa when n is an even number, the borders the every two adjacent sections joining each other are straight lines parallel to the long side of optical coupling interface between the scintillators and/or light guide;
(j) shows a pattern of two sections, one is 30, the other is 32, the section of 30 surrounds the section of 32;
(k) shows a pattern of two sections, one is 30, the other is 32, the section of 32 surrounds the section of 30;
(l) shows a pattern of two sections, one is 30, one is 32, the border the two sections joining each other is a straight line oblique to any side of optical coupling interface between the scintillators and/or light guide;
(m) shows a pattern of three sections, one is 30, two are 32, the borders the every two adjacent sections joining each other are straight lines oblique to any side of optical coupling interface between the scintillators and/or light guide;
(n) shows a pattern of five sections, two are 30, three are 32, the borders the every two adjacent sections joining each other are straight lines oblique to any side of optical coupling interface between the scintillators and/or light guide; inductively, there can be a arbitrary number (n) sections, (n−1)/2 are 30, (n+1)/2 are 32 or vice versa when n is an odd number, or n/2 are 30, n/2 are 32 or vice versa when n is an even number, the borders the every two adjacent sections joining each other are straight lines oblique to any side of optical coupling interface between the scintillators and/or light guide;
(o) shows a pattern of two sections, one is 30, one is 32, the border the two sections joining each other is a arbitrary curve;
(p) shows a pattern of multiple sections, one or more 30, the rest are 32, the shape of size of each section can be different arbitrary.

As described above, detector arrays in accordance with embodiments of the invention are designed to operate in the dot-decoding mode, the line-decoding mode, and/or the plane-decoding mode. The dot-decoding mode can be easily used to assess and calibrate the gains of the individual detectors in the array. In contrast, the conventional detector arrays, such as those disclosed in U.S. Pat. No. 6,362,479, are very difficult to perform any calibration, and hence results obtained with such conventional detector arrays will produce inaccurate images if the gains of the detectors are not balanced.

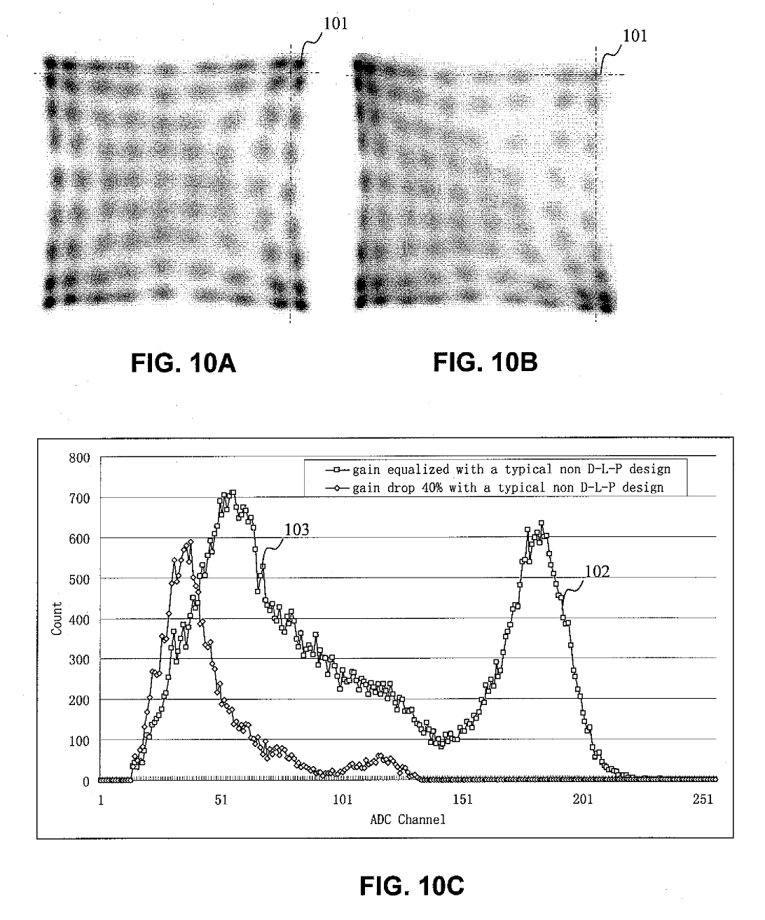

FIG. 10A and FIG. 10B show two-dimensional crystal decoding maps (i.e., scintillator position histograms) obtained with a conventional detector array (i.e., non Dot-Line-Plane design). FIG. 10A shows the results obtained in the gain equalized situation, while FIG. 10B shows the results from the detector when the gain of one photodetector drops by 40%. Based on a comparison between these two images, distortion is apparent, and it is difficult to identify the corner crystal 101 using an automatic algorithm—the corner crystal 101 is substantially outside the expected coordinate in the map of FIG. 10B. FIG. 10C provides the energy spectra for the gain-balanced (102) and gain-unbalanced (103) situations within predefined region for the corner crystal 101. It is clear that the energy spectrum 103 is significantly degraded when the gain of one photodetector drops by 40%, as compare to the energy spectrum 102 when the gains are balanced.

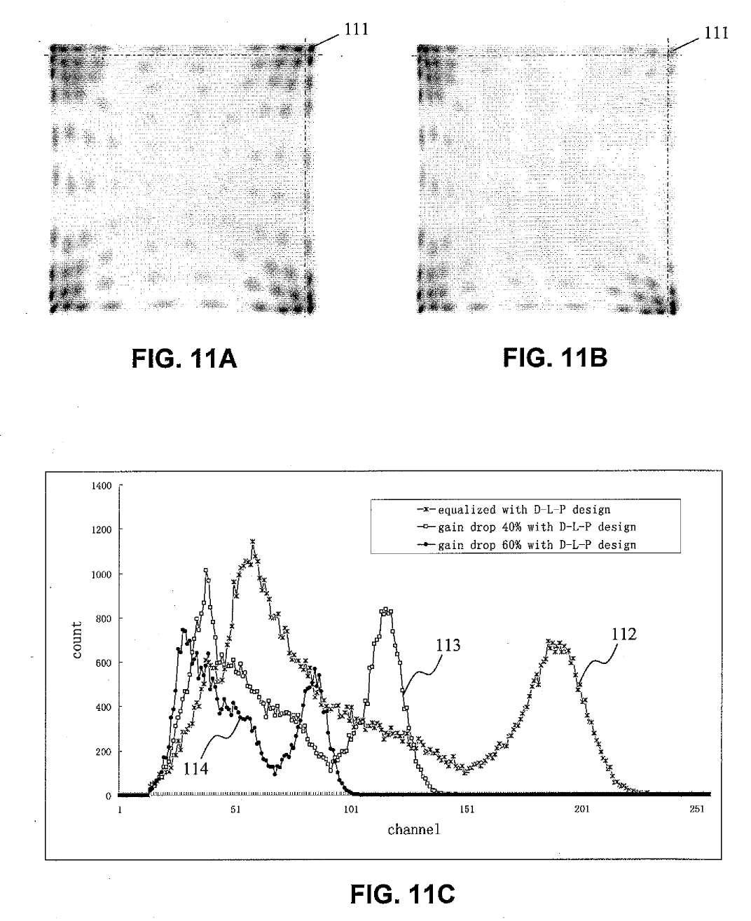

As a comparison, FIG. 11A and FIG. 11B show two-dimensional crystal decoding maps (i.e., scintillator position histograms) obtained with a detector array of the invention (i.e., a Dot-Line-Plane design). FIG. 11A show s results obtained when the gains of the detectors are equalized, while FIG. 11B shows results obtained when the gain of one photodetector drops by 40%. It is clear that far less distortion appears in the dot-decoding crystal mapping area—the corner crystal 111 is found within the defined coordinate in both situations.

FIG. 11C provides the energy spectra within the predefined margins of the dot-decoding crystal 111. The spectra clearly indicates that good energy spectrum remains even when the gain of one photodetector drops 60%. This unique feature can be used to construct an automatic algorithm to identity the Dot-decoding crystals and further use their spectra to equalize the gains of the photodetectors, as illustrated in a gain equalization process shown in FIG. 12. Importantly, in a preferable case, the gamma source irradiating the scintillator detectors can be a tracer injected into patients (positron emitting tracers for PET, or gamma-emitting tracers for SPECT and Gamma Camera). Therefore, in accordance with embodiments of the invention, gain equalization can be automatically performed on the fly while the scanning is in progress.

FIG. 12 shows one exemplary method for equalizing gains of a detector array in accordance with embodiments of the invention. As shown in FIG. 12, a method 120 may start with irradiating the detectors with a known gamma source (step 121). The signals are recorded to obtain the scintillator position histograms, which are used to identify the dot-decoding scintillators and define the margins of the dot-decoding scintillators (step 122). Note that step 122 is required only when a system modification is made, such as after the first factory setup, after replacement of components, or when scheduled quality assurance calibration is needed.

Identification of a dot-decoding scintillator can be accomplished as follows. FIG. 10A, FIG. 10B, FIG. 11A, and FIG. 11B show scintillator position histograms, which are usually displayed as 2-dimensional intensity images. Each spot on the scintillator position histograms represents a scintillator crystal position. Therefore, by studying these images and spots, the boundaries of each spot can be determined and used to register each scintillator. In common practice, Look-Up-Table can be created to store the spot boundary and scintillator registration information and to provide real-time scintillator identification. As showed in FIG. 11A and FIG. 11B, owing to its minimum light cross-talk with the other photo-detectors, the dot-decoding scintillators is not sensitive to the gain variations, and their mapping spots in the scintillator position histograms do not change locations significantly even if the gains are severely un-equalized. Therefore, the predetermined decoding boundary and scintillator registration information are valid for the identification of the dot-decoding scintillators within a large gain variation range.

Once the dot-decoding scintillators are located, obtain the energy spectra of the dot-decoding scintillators by using the margins (i.e. boundaries of the spots in the scintillator position histograms) defined in the previous step (step 123). Next, one compares the energy spectra to the pre-defined photo-peak or spectrum shape based on an acceptance criterion that is set according to knowledge of the source (step 124). From the comparison (step 125), if the energy spectrum of each dot-decoding scintillator does not meet the acceptance criterion, then one adjust the gain of the photon-detector signal chain accordingly (step 126) and repeat step 123. On the other hand, if the energy spectrum of each dot-decoding scintillator meets the acceptance criterion, then one keeps the current gain of the PMT signal chain (step 127). If the gains of all PMT signal chains are accepted (step 128), then the PMT gain equalization is done (step 129). Otherwise, one repeats step 123. Photon-detector (or PMT) signal chain means the path that the electrical signal generated by the photon-detector goes through until it mixes with other signals and no longer independently exists. For instance, the whole path may include the photon-detector, analog and/or digital signal processing circuitries dedicating to the electrical signal from the photon-detector. Gₜₒₜₐₗ=G_{PD}*G_{ananlog}*G_{digital}, where Gₜₒₜₐₗ is the total gain of the entire signal chain, G_{PD} is the gain of photon-detector, G_{ananlog} is the gain of the analog processing circuitries, and G_{digital} is the gain of the digital processing circuitries. To equalize the gains can be effectuate as keeping Gₜₒₜₐₗ constantly, one can adjust one or more amongst G_{PD}, G_{ananlog}, G_{digital} depending upon the particular system design.

The above examples use dot-decoding detectors for gain monitoring and calibration. Some embodiments of the invention may use line-decoding detectors for gain monitoring and calibration in a similar manner. As noted above, the line-decoding detectors have light-sharing minimization features (e.g., light reflector coatings) to limit the light spread to adjacent photodetectors in a line. These light-sharing minimization features make the line-decoding detectors less prone to errors caused by gain imbalance among the detectors. Some embodiments of the invention may use both dot-decoding and line-decoding detectors for gain monitoring and calibration.

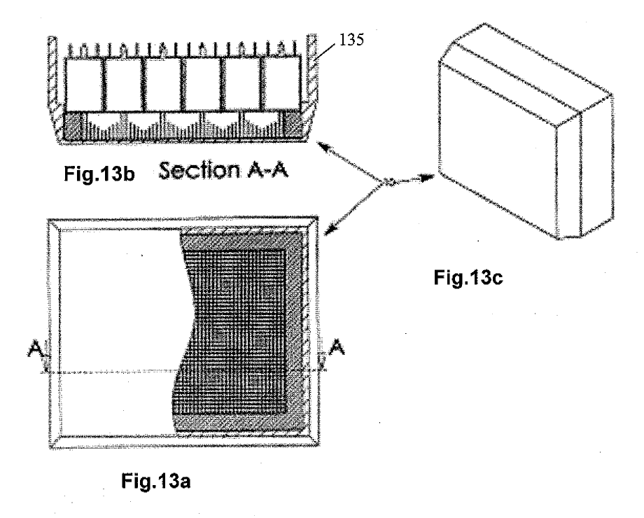

As shown in FIG. 13, a planar gamma detector module 10 comprising the discrete scintillator detectors is given as an example of practicing the invention. Although FIG. 13 shows a planar structure, it does not imply that embodiments of the present invention can only be practiced with a planar detector. In accordance with some embodiments of the invention, the multiple scintillator detectors and/or the photodetectors may be arranged in a concave or convex surface. A fixture 135 comprises one or more parts to provide mechanical support and to secure the accurate position of the scintillator detectors and photodetectors. Special parts may be introduced to the fixture to shield the scintillator detectors from background radiation and to shield the photodetectors from ambient magnetic field if necessary.

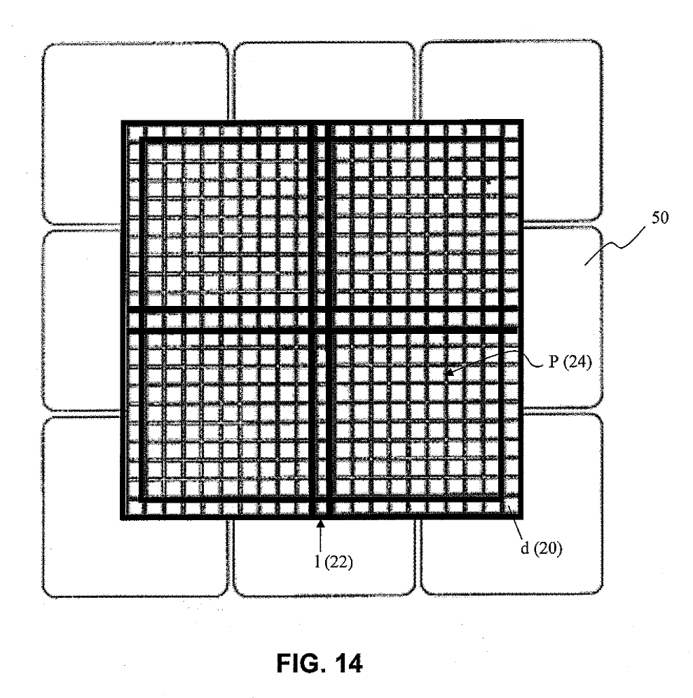

As noted above, a detector module in accordance with embodiments of the invention may have individual detectors operated in a dot-decoding, line-decoding, and/or plane-decoding mode. FIG. 14 shows one exemplary gamma detector module in accordance with one embodiment of the invention, in which the detector array includes dot-decoding, line-decoding and plane-decoding detectors. FIG. 14 shows a schematic of a detector module assembly comprises (d) dot-decoding detectors 20, (l) line-decoding detectors 22 and an (m)×(n) array plane-decoding detectors 24 optically coupled to an (s)×(t) array of photomultiplier tubes (PMTs) 50, or alternatively to an (p)×(q) array of optical detectors such as Avalanche Photodiodes (APDs) or PIN Photodiodes. Note that the variables (d), (l), (m), (n), (s), (t), (p), (q) may or may not equal each other.

The cross section of each dot-decoding detector, line-decoding detector, or plane-decoding detector may be any shape, such as rectangle, square, hexagon, polygon, or circle. Similarly, the light sensitive area of photodetectors can be any shape, including but not limited to square, rectangle, polygon, or circle. In each physical package of the photodetectors, there can be one or more identifiable sensitive elements. By regarding one or more sensitive elements within a multi-element package as one photodetector, the concept of dot-decoding, line-decoding and plane-decoding is transferable to these embodiments when multi-channel photodetectors are used.

Although it is preferred that the scintillation from the detector in dot-decoding mode is acquired only by the photodetector it reports to, some embodiments can have a small amount of optical crosstalk within a tolerable margin so long as the dot-decoding detectors are identifiable. Similarly, although it is preferable that the scintillation from the detector in line-decoding mode is acquired only by the two or more adjacent photodetectors in a line they report to, some embodiments can have a small amount of optical crosstalk within a tolerable margin so long as the line-decoding detectors are identifiable.

Some embodiments of the invention relate to apparatus capable of processing signals acquired with photodetectors that represent energy, position and time coordinates of an incident gamma ray interacting with one or more scintillator detectors of the invention. An apparatus, in accordance with embodiments of the invention, comprises a detector array described above, electronically active components (including but not limited to diodes, transistors, operational amplifiers, comparators, analog-to-digital converters, digital-to-analog converters, digital processing units, programmable devices, ASICs) and associate passive components (including but not limited to resisters, capacitors, inductors and their substitutes), as well as the components (including but not limited to connectors, cables, printed circuit board) providing interconnection to the abovementioned components.

In accordance with some embodiments of the invention, signal processing includes amplifying and filtering the signals in analog domain, digitizing the analog signal with analog-to-digital converters, computing and obtaining the energy, position and time coordinates with devices capable of digital computation, such as Application Specific Integrated Circuits (ASIC), programmable logic devices (CPLD, FPGA) and/or digital processors (DSP, CPU, etc.). With predetermined information of the system response (including both scintillator and electronics response) to a gamma interaction and Look-Up-Table technique, the energy, position and time coordinates can be obtained in real-time with a short latency.

Although not limited to medical fields, embodiments of the present invention can be beneficially used in medical imaging, wherein a single device can be used for Single Photon Imaging which includes traditional Gamma Cameras, Planar Imaging, Single Photon Emission Computed Tomography (SPECT), with or without Coincidence Photon Imaging, and Positron Emission Tomography (PET). Such Emission Computed Tomography (ECT) systems can provide a means for sensing and quantitatively measuring biochemical and/or physiological changes in the human body or other living organism.

Some embodiments of the present invention relate to a positron emission tomography (PET) cameras or scanners. Referring again to FIG. 1, a PET scanner 10 of the invention comprises a patient area 11 and a detector ring 12 for detecting radiation from opposite sides of the patient area 11. The ring 12 includes a plurality of scintillation detectors 13 (see FIG. 1B) directed towards the patient area. The scintillation detectors 13 would emit light when it interacts with gamma radiation. One or more converting means 14 (e.g., photomultiplier) are optically coupled to the scintillation detectors 13 for converting light emitted by the scintillation detectors 143 into electrical pulses. The detector ring 12 can form a full circle (FIG. 1A) or form an open configuration (FIG. 1C). The open (or partially closed) detector assembly shown in FIG. 1C is capable of simultaneously detecting photons generated from positron-electron annihilation in the patient and traveling in opposite directions. Such a two detector ring PET may be useful for imaging small objects including (but not limited to) heads, chests, breasts, hands, arms, legs, thighs, as well as small animals.

Along the incidence line of response, the time for the gamma photon to travel from the annihilation site to the scintillator depends upon the occurrence location of the annihilation. In principle, the occurrence location of the annihilation can be determined by the difference of the time when the pair of gamma photons reach the detectors. In reality, it is very difficult to measure the arrival times with accuracy. As a result, the uncertainty of the arrival time measurements leads to uncertainty of occurrence location of the annihilation. However, if the timing uncertainty is not very large (or the time resolution is not too bad), the time-of-flight information can still be used to gain additional signal-to-noise ratio (SNR) and better image quality. It is generally recognized, if the time-of-arrival uncertainty is smaller than 0.5 ns in terms of fill width at half maximum (FWHM), extra signal-to-noise ratio (SNR) can be gained with time-of-flight PET, while compared the similar PET without time-of-flight feature. It is also obvious that the better timing resolution can be achieved, the more signal-to-noise ratio (SNR) can be advanced.

Accurate time-of-flight measurement requires high light output fast scintillators, such as Gadolinium Oxyorthosilicate (GSO), Cerium doped Lutetium-Yttrium Oxyorthosilicate (LYSO) and Lutetium Oxyorthosilicate (LSO), Lanthanum Halide scintillator (for example, LaCl₃ and LaBr₃), as well as efficient light collection scheme. In general, directly coupling the scintillators to the photon detectors collects more light than those coupling through a light guide. Therefore, better timing resolution may be achieved with directly coupling the scintillators to the photodetectors.

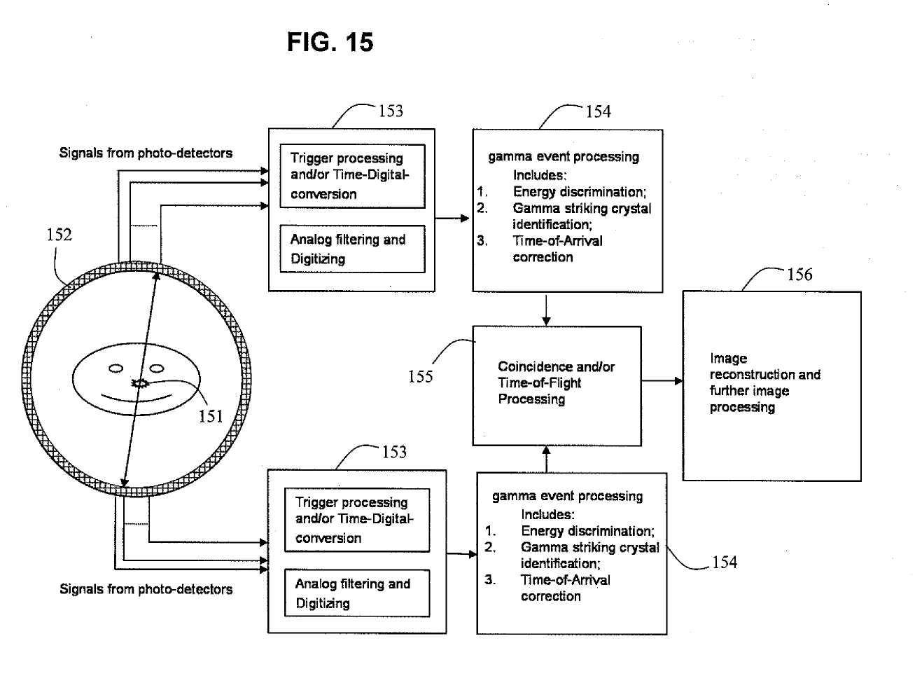

The data acquisition and processing is illustrated in FIG. 15. As shown, a radiation source 151 generates two gamma rays traveling in opposite directions to arrive at the circular detector array 152. The interactions between the gamma rays and the scintillator detectors in the detector array 152 generate lights that are measured by photodetectors in the detector array 152. The interactions will simultaneously generate electrical signals having a fast leading edge. The faster the leading edge, the better time resolution can be obtained, which in turn leads to better signal to noise ratio and better image quality for both TOF and non-TOF PET. Compared to non-TOF PET, more improvement can be made with TOF PET, if the time resolution is better than 0.5 ns.

The signals collected by the photodetectors are forwarded to process 153, which may perform analog filtering, analog-digital conversion, and/or time-digital conversion. After such pre-processing, the signals may be further processed by another process 154 to derive gamma interaction information, including energy discriminations, gamma striking crystal identification, time of arrival correction, position, etc.

Further processing (process 155) can be performed on the derived gamma interaction information either prior to or after the coincidence processing: 1) to correct systematic measurement errors; 2) to select the appropriate gamma events according to the acceptance criteria set by the system design (e.g., the energy window that indicates non-scattered gamma). With the gamma interaction information, the coincidence analysis may be performed to identify pairs of gamma photons from the same annihilation event from a large number of gamma events detected by the detectors. Finally, an image may be reconstructed and/or further processed by yet another process 156. Based coincidence gamma interaction information, many different algorithms can be used to reconstruct the tomographic images.

Note the description of individual processors in FIG. 15 is for clarity of description. These separate processes described above may be implemented on the same or different physical units and/or in the same or different algorithms. Furthermore, these processes may be implemented in analog and/or digital circuitries.

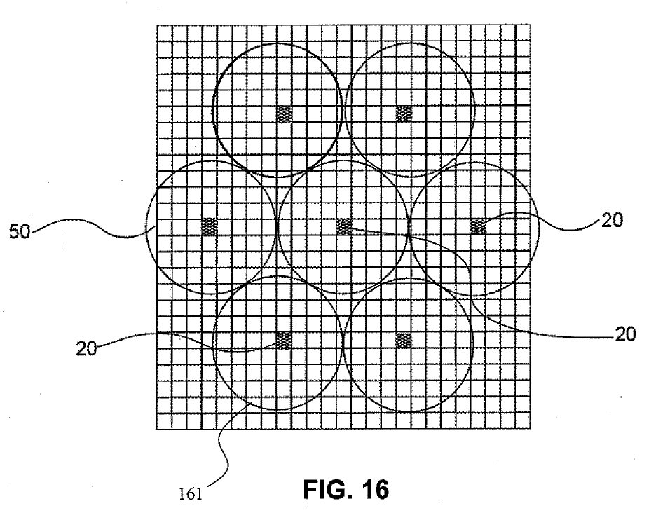

The above description uses square shaped crystals and photodetectors to illustrate embodiments of the invention. One of ordinary skill would appreciate that other shaped scintillation detectors and/or photodetectors may be used with departing from the scope of the invention. For example, FIG. 16 shows a common gamma detector design which has scintillator detector array coupling to hexagonally disposed photo-detectors. This design and its slightly revised forms can be found in many nuclear medical imaging instruments, such as Gamma camera, SPECT as well as PET. Though the currently available instruments have not implemented dot-decoding mode, FIG. 16 also demonstrates an embodiment of using the dot-decoding detectors to exploit their unique feature of being insensitive to the gain variations of the photo-detectors and further to realize gain equalization. In this embodiment, both center positioned and off-center positioned dot-decoding detectors are implemented.

Advantages of embodiments of the invention may include one or more of the following. Embodiments of the invention relate to gamma detector arrays having detectors that can be operated in dot-decoding mode, line-decoding mode, and plane-decoding mode. Having the dot-decoding mode allows a detector array of the invention to have an easy way to assess and balance the gains of the individual detectors in the array. Being able to balance the gains of the detectors easily makes it possible to perform gain monitoring and calibration on the fly, even during clinical use. Detector arrays of the invention can be made with the same dimensions of the existing detector arrays. Therefore, they can be readily adapted for use with existing imaging machines.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A gamma ray detector module, comprising:
at least one scintillation detector configured to operate in a dot-decoding mode, or at least two scintillation detectors configured to operate in a line-decoding mode, wherein the at least one scintillation detector is each coupled to a single photodetector, and wherein the at least two scintillation detectors are coupled to at least two photodetectors arranged substantially along a line; and
at least four scintillation detectors configured to operate in a plane-decoding mode, wherein the at least four scintillation detectors are coupled to a plurality of photodetectors arranged in a two-dimensional array.

2. The gamma ray detector module of claim 1, wherein the gamma ray detector module is part of a gamma ray camera for use with a medical instrument.

3. The gamma ray detector module of claim 2, wherein the medical instrument is a positron emitter tomography (PET) or a single photon emission computed tomography (SPECT) instrument.

4. A method for imaging a gamma ray source, comprising:
obtaining gamma ray measurements using a detector module comprising:
at least one scintillation detector configured to operate in a dot-decoding mode, or at least two scintillation detectors configured to operate in a line-decoding mode, wherein the at least one scintillation detector is each coupled to a single photodetector, and wherein the at least two scintillation detectors are coupled to at least two photodetectors arranged substantially along a line; and
at least four scintillation detectors configured to operate in a plane-decoding mode, wherein the at least four scintillation detectors are coupled to a plurality of photodetectors arranged in a two-dimensional array; and
balancing gains of the scintillation detectors in the detector module using measurements obtained by the at least one scintillation detector operating in the dot-decoding mode or the at least two scintillation detector operating in the line-decoding mode.

5. The method of claim 4, further comprising acquiring a second set of gamma ray measurements after the balancing the gains of the scintillation detectors.

6. The method of claim 5, further comprising deriving an image of a gamma ray source using the second set of gamma ray measurements:
